(19) United States
(12) Patent Application Publication
(10) Pub. No.: US 2019/0308047 A1
(43) Pub. Date: Oct. 10, 2019

(54) Pipe arrangement of a Pipeline System of a Fire Extinguishing System, Pipe Connector for such Arrangement, and Method for Producing such a Pipe Arrangement

(71) Applicant: MINIMAX GMBH & CO. KG, Bad Oldesloe (DE)

(72) Inventors: Klaus HOFMANN, Bad Oldesloe (DE); Joachim BÖKE, Düsseldorf (DE)

(21) Appl. No.: 16/374,834

(22) Filed: Apr. 4, 2019

(30) Foreign Application Priority Data
Apr. 4, 2018 (DE) 10 2018 107959.1

(51) Int. Cl. A62C 35/68; F16L 13/02; F16L 13/10

(52) U.S. Cl. CPC A62C 35/68; F16L 13/103; F16L 13/0236

(57) ABSTRACT

The invention relates to a pipe arrangement (1, 1′, 1″,1′″) of a pipeline system of a fire extinguishing system having interconnected media-conducting pipe sections, comprising a sleeve body (2, 2′, 2″) which has at least one first end section (4) and a second end section (4), in particular two pipe sections (6, 6), wherein each pipe section (6, 6′) is accommodated on an end section (4, 4′) of the sleeve body (2, 2′, 2″), and a sealing element (12, 12′, 12″) arranged between an inner side (8) of the sleeve body (2, 2′, 2″) and an outer surface (10) of the pipe section (6, 6), wherein a connecting means (14, 14′) arranged between the inner side of the sleeve body (2, 2′, 2″) and the outer surface of the pipe section (6, 6′).

According to the invention, it is proposed that the connecting means (14, 14′) has a transport and/or storage state in which a relative movement between the pipe sections (6, 6′) and the sleeve body (2, 2′, 2″) is possible, and which can be brought by means of activation from the transport and/or storage state into a connecting state, wherein, in the connecting state, the connecting means (14, 14′) is configured to connect an outer surface (10) of the respective pipe end to the inner side (8) of the sleeve body (2, 2′, 2″) by material bonding.

This application claims priority to German Application No. 10 2018 107 959.1 filed Apr. 4, 2018, which is incorporated by reference in its entirety.

### BACKGROUND

### 1. Field of Invention

The invention relates to a pipe arrangement of a pipeline system of a fire extinguishing system having interconnected media-conducting pipe sections, comprising a sleeve body which has at least one first end section and a second end section, two pipe sections, wherein each pipe section is accommodated on an end section of the sleeve body, and a sealing element arranged between an inner side of the sleeve body and an outer surface of the pipe section. Furthermore, the invention also relates to a method for producing a pipe arrangement of two pipelines, to be connected to each other, of a pipeline system of a fire extinguishing system.

### 2. Prior Art

In order to connect or couple media-guiding pipelines in sprinkler technology, use is customarily made of couplings or threaded connections. By means of such couplings or threaded connections, firstly a fixed mechanical coupling between the pipelines of a fire extinguishing system is intended to be brought about and, secondly, sealing to the outside is intended to be ensured despite the pressures acting within the pipeline system. In rare cases, press connections are also used in addition to the known couplings. In the case of pipeline systems which are formed in regions from plastics pipes, the individual pipelines can also be connected to one another via welded or adhesive connections.

For example, the prior art discloses pipe arrangements which have a sleeve body, which comprises at least one first end section and a second end section, and two pipe sections, wherein each pipe section is accommodated in an end section of the sleeve body. A sealing element, in particular an elastic sealing element, is arranged between an inner side of the sleeve body and the outer surface of the pipe section, by means of which sealing element the sealing of the pipe sections from one another or the sealing between the outer surface of the pipe section and the inner side of the sleeve body is brought about.

A pipe arrangement of this type is known, for example, from U.S. Pat. No. 5,584,512 A. Provided in the bottom region of the two pipe ends is a sealing ring with which the pipe ends are each in contact on the end side and via the pipe outer side with the inner side of a sleeve body in a sealing manner. Furthermore, annular grooves in which snap rings are arranged are provided on the inner side of the sleeve. When the pipe ends are pushed into the sleeve, the snap rings enter into a form-fitting connection with corresponding annular grooves on the outer side of a respective pipe end. Furthermore, an adhesive can be applied to the outer side of a pipe end before the insertion into the sleeve, said adhesive curing after the pushing into the sleeve. In order to ensure an effective integrally bonded connection between the outer surface of the pipe end and the inner side of the sleeve, the adhesive surfaces should be neatened and optionally subjected to further pretreatment steps. However, this has a disadvantageous effect on the assembly times of such a pipe connection. In addition, when the pipe end is brought into the sleeve body, there is the difficulty of not prematurely removing the connecting means, which is applied to the outer surface of the pipe end, by means of the snap ring, which lies against the outer surface of the pipe end, during the pushing in, which would eliminate the effectiveness of the applied connecting means.

### SUMMARY OF THE INVENTION

The invention therefore suggests to specify a pipe arrangement and a method for producing a pipe arrangement, by means of which shortened assembly times of the pipe arrangement and also high effectiveness of the adhesive connection are achieved.

In a first aspect, the invention achieves the object on which it is based in the case of a pipe arrangement of a pipeline system of a fire extinguishing system. A preferred embodiment includes a pipe arrangement of a pipeline system of a fire extinguishing system having interconnected media-conducting pipe sections, comprising a sleeve body which has at least one first end section and a second end section, two pipe sections, wherein each pipe section is accommodated on an end section of the sleeve body, and
a sealing element arranged between an inner side of the sleeve body and an outer surface of the pipe section. In particular, the pipe arrangement includes a connecting means arranged between the inner side of the sleeve body and the outer surface of the pipe section is provided, wherein the connecting means has a transport and/or storage state in which a relative movement between the pipe sections and the sleeve body is possible, and which can be brought by means of activation from the transport and/or storage state into a connecting state, wherein, in the connecting state, the connecting means is configured to connect an outer surface of the respective pipe section to the inner side of the sleeve body by material bonding.

According to the invention, the approach here is pursued that the connecting means is activated either shortly before introduction into the sleeve body or directly after introduction into the sleeve body and is thereby transferred from its transport and/or storage state into its connecting state. The effect which is therefore achieved is that the adhesive properties of the connecting means become effective only shortly before or after the joining of the pipe section to the sleeve body. For the joining, the outer surface of the pipe section is brought into contact at least in sections with the inner side of the sleeve body. The pipe section is preferably supplied to an assembly site with a connecting means already applied to the outer surface, with the connecting means accordingly being inactive in its transport and storage state. During the production of the pipe section, the connecting means is preferably applied to same and shifted from its inactive state into the active state only when required. A connecting means which is still inactive does not yet have towards the environment any adhesive properties typical for an material bonding connection. The inner side preferably is an inner circumferential surface of the sleeve body. The outer surface preferably is an outer circumferential surface of the pipe section.

According to a preferred refinement of the pipe arrangement according to the invention, wherein an adhesive or welded connection is formed between the sleeve body and the pipe sections by means of the connecting means. The adhesive bonding or welding constitutes a preferred possibility for forming an material bonding connection between two components to be connected to each other. Furthermore, a secure mechanical coupling of the components to be connected (sleeve body and pipe section) and locking of the components with respect to each other are achieved. After the production of the adhesive or welded connection, a relative movement of the pipe section with respect to the sleeve body is effectively prevented. In addition to a mechanical locking, a sealing effect can additionally be obtained by means of the adhesive or welded connection in addition to the sealing element used between the outer surface of the pipe section and the inner side of the sleeve body.

The connecting means is preferably an adhesive or weldable plastic applied on the inner side of the sleeve body and/or the outer surface of the pipe section. One or more sections of the pipe section or of the end section of the sleeve body are provided with an adhesive or a weldable plastic. The connecting means is preferably applied to the outer surface of the pipe section or the inner side of the sleeve body over the entire circumference. In one embodiment, the connecting means is applied along a section in the longitudinal direction of the pipe section and/or of the sleeve body. The section is approximately one eighth to approximately half of the overall length of the plug-in connection formed between the pipe section and the sleeve body.

According to a preferred embodiment, the connecting means is a single- or multi-component adhesive, preferably a two-component adhesive. In the case of a two-component adhesive, it is preferably provided to arrange one component of the two-component adhesive on the inner side of the sleeve body and to arrange the second component of the two-component adhesive on a corresponding section on the outer surface of the pipe section. When the pipe section is mounted on the sleeve body, the two components enter into contact with each other and thus set the activation of the connecting means into motion, and therefore the connecting means is transferred from the transport and storage state into the connecting state. Preferably, the components of the two-component adhesive by themselves in each case do not have an adhering property when they are applied individually to the corresponding sections of pipe section and sleeve body.

According to a preferred refinement of the pipe arrangement according to the invention, a section of a conically running connecting surface is in each case provided on the inner side of the sleeve body and on the outer surface of the pipe section. The effect therefore achieved during the joining, in particular during pushing, of the pipe section into the sleeve body is that surface regions of the pipe section and surface regions of the end section of the sleeve body have contact surfaces lying directly against each other. A contact pressure of predetermined strength against the conically running connecting surfaces can preferably be produced with the connecting means applied at least on one side, as a result of which the adhesive effect of the connecting means, which is preferably in the form of an adhesive, is improved.

The sleeve body preferably has a conical connecting surface widening in each case in the direction of its ends, and the pipe sections to be connected to the sleeve body have a connecting surface tapering in the direction of the pipe end.

The connecting means preferably is covered by a removable protective layer, wherein the protective layer is configured to shield the connecting means from external influences in the transport and/or storage state. With the aid of the protective layer, the connecting means can be kept as long as necessary in the inactive state.

In addition, the protective layer likewise provides active protection against possible contact with any environmental influences which may possibly have a disadvantageous influence on the adhesive forces which can be achieved by means of the connecting means.

In one embodiment of the invention, the protective layer is a protective film which completely surrounds the connecting means, such that the connecting means is preferably completely enclosed. In embodiments where the connecting means has been provided on the pipe section, the protective layer preferably is positioned on the side facing the sleeve body. In embodiments where the connecting means has been provided on the sleeve body, the protective layer preferably is positioned on the side facing the pipe section.

In one embodiment of the invention, the protective film is designed to be removed from the connecting means when the pipe section has already been pushed into the end section of the sleeve body. This avoids the connecting means being unintentionally displaced from its designated position on the pipe section, or the sleeve body, as the case may be, as the pipe section is being pushed into the sleeve body. Accordingly, the connecting means is activated only after the pipe section is inserted into the end section of the sleeve body by way of removing the protective layer. For achieving this, the protective layer preferably comprises a tab or other structural projection extending away from the connecting means and away from the sleeve body, and being externally accessible after insertion of the pipe section into the sleeve body. Proper dimensioning of the pipe section and connecting means provided, the projecting tab can then be pulled out from between the sleeve body and the pipe section to activate the connecting means.

In a preferred embodiment, the removable protective layer is at least one of: air tight, splash water repellent, or impermeable to UV radiation.

In a preferred embodiment, the connecting means is configured to transition into the connecting state with removal of the protective layer. In embodiments using adhesive as connecting means, the adhesive characteristics emerge with respect to the opposite part.

According to a preferred embodiment of the invention, the sealing element in arranged in a depression on the inner side of the sleeve body and/or on the outer surface of the pipe section. The depression is preferably formed in the manner of a groove and runs around over the entire circumference on the inner side of the sleeve body and/or the outer surface of the pipe section. The depression forms a type of receiving space for the sealing element, said receiving space preferably forming a sealing region with the oppositely arranged surface of, for example, the pipe section or the sleeve body.

In a preferred development of the invention, the inner side of the sleeve body and the outer surface of the pipe section define a receiving space for receiving the connecting means, wherein an opening corresponding to the receiving space for the entry of the connecting means or an initiator or a component of the connecting means is provided on the sleeve body. In one embodiment, during the introduction of the pipe section into the sleeve body, connecting means can flow out of the receiving space into an adjacent surface region which acts as a connecting region between the pipe and sleeve body. In a further embodiment of the invention, the connecting means is only entered retrospectively into the receiving space, which is present between the inner side of the sleeve body and the outer surface of the pipe section, for the connecting means. The entry of the connecting means constitutes, for example here, the activating of the connecting means. The receiving space is preferably formed by groove-like depressions on the inner side of the sleeve body and the outer surface of the pipe section, said groove-like depressions being arranged congruently in the assembled state of the pipe arrangement. The connecting means enters the receiving space according to the invention via at least one or more filling openings on the sleeve body, via which the connecting means can be applied in a controlled manner into the receiving space.

In a further preferred embodiment of the invention, the connecting means as a single-component adhesive is located in a depression, forming the receiving space, on the pipe section or the sleeve body. An initiator, such as, for example, a radical starter, UV or heat radiation, is input or applied via the opening, corresponding to the receiving space, in the sleeve body and acts on the connecting means in order to start the curing of the connecting means.

The connecting means used can also be a two-component adhesive, one component of which has already been introduced in advance into the receiving space. A second component of the two-component adhesive can then be entered via the opening and reacts with the first component located in the receiving space.

The receiving space is preferably connected in a fluid-conducting manner to two adjacent surface regions between the inner side and the outer surface, as a result of which the connecting region extends laterally beyond the receiving space for the connecting means. The receiving space for the connecting means preferably forms an annular space which extends over the entire circumference between the pipe section and the sleeve body.

According to a development of the pipe arrangement according to the invention, a locking element for axially positioning the pipe sections with respect to the sleeve body is provided. With the aid of the locking element, the locking or positioning of the pipe section pushed into the end section of the sleeve body takes place relative to each other. The locking element is configured in order, with the pushing in and the reaching of an assembly position of the pipe section in the sleeve body, to bring about a form-fitting connection with the two components. The locking element is preferably a type of snap ring which can be brought into engagement with annular grooves correspondingly provided on the outer surface of the pipe section and the inner side of the sleeve body.

According to a preferred embodiment of the invention, the sleeve body has at least one stop for the pipe sections pushed into the sleeve body, wherein the stop is preferably designed as a radially inwardly projecting shoulder on the inner side of the sleeve body. The maximum push-in depth for a pipe section to be connected to the sleeve body is limited by means of the stop on the inner side of the sleeve body. It is thereby ensured that the pipe sections are arranged uniformly, preferably symmetrically, within the sleeve body. A permanently effective sealing of the pipe arrangement according to the invention is thereby ensured. The stop which is formed on the inner side of the sleeve body is a radially inwardly projecting material projection which forms a shoulder in the inside diameter. The pipe sections pushed into the sleeve body preferably abut obtusely with their ends against a circular-ring-shaped stop surface of the shoulder.

The connecting regions formed by means of the connecting means are preferably at a distance from the respective end of the pipe section that is greater than the distance of the sealing element from the end of the pipe section. The connecting means is therefore preferably arranged behind a respective sealing element in the push-in direction of the pipe section. This contains the advantage that the connecting means, when applied to the pipe section, is pushed last into the end section of the sleeve body. The friction acting on the outer side of the applied connecting means because of the surface regions of the sleeve body moving relative thereto is therefore comparatively small.

Alternatively, the connecting regions formed by means of the connecting means are preferably at a distance from the respective end of the pipe section that is smaller than the distance of the sealing element from a respective pipe end. The connecting means is therefore preferably arranged before a respective sealing element in the push-in direction of the pipe section. In this embodiment, the sealing element, which is designed, for example, as an elastic sealing element, such as, for example, an encircling sealing lip, does not enter into contact with the fluid flowing through the pipelines if a sealing function is likewise carried out by means of the material bonding connection, which can be designed as an adhesive or welded connection. The connecting means arranged in front of the sealing element at the pipe end in the plugging-in direction is preferably formed from a two-component adhesive, wherein the two components are individually in the inactive state and are only transferred into the active state by contact with each other. In another embodiment, a weldable plastic is to be applied to a respective pipe section in the region in the vicinity of the pipe end, said plastic being liquefied by heating of the weldable plastic after the pipe ends are pushed into the sleeve body, and an material bonding connection between the pipe sections of the sleeve body surrounding the pipe sections is thereby achieved.

In the circumferential direction of the pipe section, the connecting means preferably has cooling ducts extending substantially in the axial direction. In the circumferential direction of the pipe section, the connecting means is preferably applied only in regions, as a result of which an exclusively mechanical coupling is obtained between the sleeve body and the pipe sections accommodated therein. The sealing function is obtained exclusively via the sealing element. The extinguishing fluid flows through the cooling ducts in approximately the axial direction to sealing elements preferably arranged on the end side. In the event of a fire and therefore upon triggering of a fire extinguishing system, a sealing element arranged on the end side is cooled by the flowing extinguishing fluid. This improves the functional capability of the sealing element, which can be exposed to an excessive production of heat, in the event of a fire. At least two, three or more connecting regions separated from one another are preferably provided in a respective connecting region in the circumferential direction between the outer surface of the pipe section and the inner side of the sleeve body. The through channels for the extinguishing fluid are preferably arranged symmetrically around the longitudinal axis of the pipe arrangement.

According to a preferred development of the pipe arrangement, insulation is arranged on the outer surface of the sleeve body. In particular the sleeve body and at least one pipe section region arranged adjacent to the sleeve body is in particular encased by means of insulation. The region encased by the insulation is therefore protected against an excessive action of heat or harmful effects of a fire. In the event of a fire, high functional reliability of the pipe connection based on bonded material bonding connection is achieved. The insulation is formed by means of a suitable insulating material, such as, for example, a mineral absorbing material or a material based on plastic.

The invention relates in a further aspect to a fire extinguishing system with a pipeline system consisting of a plurality of media-guiding pipelines which are connected to one another in a fluid-conducting manner.

The fire extinguishing system according to the invention achieves the object described at the beginning by the connecting region of at least two pipelines connected to one another being formed by means of a pipe arrangement according to one of the above-described preferred embodiments. The invention is based on the finding that a fire extinguishing system can be assembled in a simplified manner with a multiplicity of pipe arrangements which are designed according to the invention and are used for connecting a multiplicity of pipelines. Plastics pipes or pipelines made up from metal are preferably used as the pipeline. In addition, high functional reliability of the fire extinguishing system is ensured, the connecting regions of which have an activatable coupling means with which at least the mechanical coupling of the components of a pipe arrangement that are to be connected to one another takes place. According to a preferred embodiment of the invention, the sleeve body can be designed as a cylindrical sleeve body, the end sections of which are arranged coaxially for the connection of the pipe section. However, the sleeve body can also have an angled orientation of the end sections. The longitudinal axes of the end sections can be oriented, for example, running at an angle within the range of between 1° and 89° with respect to each other. Instead of two end sections for the connection to a respective pipe section, the sleeve body can also be designed as a T connector or X connector to which three or more pipe ends of a pipeline system of a fire extinguishing system are connected to one another in a media-conducting manner.

The benefits and preferred embodiments of the first aspect are at the same time benefits and preferred embodiments of the second aspect. Reference is made to the explanations given above in order to avoid unnecessary repetition.

The invention has been discussed with respect to a first and second aspect above. In a third aspect, the invention relates to the pipe connector itself.

The invention suggests a pipe connector for a pipe arrangement of a pipeline system of a fire extinguishing system, said system having a plurality of interconnected fluid-conducting pipe sections, wherein the pipe connector comprises a sleeve body that comprises a first end section for receiving a first pipe section of the pipe arrangement and a second end section for receiving a second end pipe section of the pipe arrangement, wherein the sleeve body preferably comprises an inner side, and preferably a sealing element arranged on the inner side, wherein the sleeve body comprises a connecting means that is arranged on the inner side of the sleeve body, said connecting means being configured to connect to an outer surface of the respective pipe section, wherein the connecting means has a transport and/or storage state in which a relative movement between the pipe sections and the sleeve body is possible, and which is configured to be activated from the transport and/or storage state into a connecting state, wherein in the connecting state, the connecting means is configured to connect to an outer surface of the respective pipe section by material bonding.

The benefits and preferred embodiments of the pipe arrangement and the fire extinguishing system of the first and second aspects are at the same time benefits and preferred embodiments of the pipe connector such that in order to avoid unnecessary repetition, reference is made to the explanations hereinabove.

According to a preferred embodiment, the connecting means is a single- or multi-component adhesive, preferably a two-component adhesive.

In the case of a two-component adhesive, preferably one component of the two-component adhesive is arranged on the inner side of the sleeve body, while the second component of the two-component adhesive will be arranged on the outer surface of the pipe section that is to be inserted into the sleeve body, cf. the embodiments described hereinabove. When the pipe section is mounted on the sleeve body, the two components enter into contact with each other and thus set the activation of the connecting means into motion such that the connecting means is transferred from the transport and storage state into the connecting state.

Preferably, the components of the two-component adhesive by themselves in each case do not have an adhering property when they are applied individually to the corresponding sections of pipe section and sleeve body.

According to a fourth aspect, the invention relates to a method for producing a pipe arrangement from two pipelines, to be connected to each other, of a pipeline system of a fire extinguishing system. The pipe arrangement is preferably formed according to one of the above-described preferred embodiments of the first, second or third aspects.

The method according to the invention likewise achieves the object described at the beginning with the steps: providing two pipe sections to be connected to each other and a sleeve body for receiving at least sections of the pipe sections, joining the pipe sections to the sleeve body, and activating a connecting means, which is arranged on an inner side of the sleeve body and/or an outer surface of the pipe section, before or after the joining and transfer of the connecting means from a transport and/or storage state in to a connecting state such that the inner side of the sleeve body is at least partially connected by material bonding to the outer surface of the pipe section by means of the activated connecting means. With the aid of the method steps according to the invention, a connecting means applied to a portion of the outer surface of a pipe section or to the portion of the inner side of the sleeve body is provided, in particular activated, in such a manner that it obtains its adhesive forces only shortly before a pipe section is introduced into the sleeve body or after the pipe section is introduced into the sleeve body. The connecting means is therefore transferred from a state in which the connecting means is inactive and therefore no adhesive forces act on an oppositely arranged connecting surface, into a state in which the connecting means applied to the outer surface of the pipe section and/or the inner side of the sleeve body can now build up adhesion forces with respect to the adjacent connecting surface of the oppositely arranged component.

A preferred development of the method according to the invention provides the step: fixing the pipe section and the sleeve body with respect to each other after the joining of the pipe section to the sleeve body until the at least partial material bond between the inner side of the sleeve body and the outer surface of the pipe section is set. The pipe section and the sleeve body are preferably fixed with respect to each other immediately before or after the activation of the connecting means. According to one embodiment, pipe section and sleeve body are fixed with respect to each other for as long as the connecting means is still liquid, or until the at least partially material bond between the inner side of the sleeve body and the outer surface of the pipe section has been set. The fixing preferably takes place using a fixing apparatus which secures the sleeve body with respect to at least one pipe section in the axial direction and/or in the circumferential direction of the outer surface of the pipe section.

According to a preferred refinement, in order to activate the connecting means before or after the connection of the pipe sections to the sleeve body, the method according to the invention comprises one, more than one or all of the following steps:
a) removing a protective layer covering the connecting means, b) generating heat at the connecting means such that the connecting means liquefies, and subsequently cooling the connecting means in order to solidify the connecting means, and c) entering the connecting means or an initiator or a component of the connecting means into a receiving space, which is formed between the inner side of the sleeve body and the outer surface of the pipe section, for receiving the connecting means via an opening corresponding to a receiving space.

For the activation, either a protective layer, such as, for example, a protective film, on a connecting means, in particular an adhesive, applied to, for example, a pipe end of a pipe section, is therefore removed. In an alternative embodiment, after the joining of the pipe section to the sleeve body, a weldable plastic already applied to a pipe end of a pipe section is liquefied by introduction of heat into the region on the sleeve body, and therefore the liquefied plastic bonds to the, for example, previously not connected inner side of the sleeve body. The liquefied plastic is subsequently cooled again, as a result of which a permanently fixed connection is produced between pipe section and sleeve body. In a further alternative embodiment, a single-component adhesive or an initiator for a single-component adhesive or a component of a two-component adhesive is entered via an opening, such as, for example, a filling opening, in a region of the sleeve body into a receiving space formed between the inner side of the sleeve body and the outer surface of the pipe section. The connecting means entered into the receiving space preferably enters into contact over the full circumference with the inner side of the sleeve body and the outer surface of the pipe sections and cures in the receiving space. An initiator introduced via the opening enters into contact with a connecting means already located in the receiving space, or a second component of a two-component adhesive enters into contact with a first component of the two-component adhesive, said first component already being located in the receiving space. As initiator for a single-component adhesive, use is made, for example, of a radical starter, UV or heat radiation for curing the connecting means.

The preferred embodiments or developments described with respect to the pipe arrangement according to the invention are at the same time also preferred embodiments of the fire extinguishing system according to the invention and of the method according to the invention for producing a pipe arrangement.

According to a further aspect, the invention also relates to a system for installation of a pipe, with a pipe arrangement according to one of the above-described preferred embodiments and an apparatus for fixing at least one pipe section and a sleeve body to be connected to the pipe section. The system according to the invention likewise achieves the object described at the beginning by the fixing apparatus having at least one fixing means which acts on the pipe section and the sleeve body and is configured to secure the pipe section and the sleeve body in the axial direction and/or in the circumferential direction of their mutually facing inner side and outer surface at least temporarily with respect to each other.

With the aid of the fixing apparatus, the pipe section and the sleeve body to be connected to the pipe section can be temporarily secured with respect to each other until an at least partial material bond between the inner side of the sleeve body and the outer surface of the pipe section in the axial direction and/or in the circumferential direction of their mutually facing inner side and outer surface is set. An undesired relative movement of pipe section and sleeve body with respect to each other during the setting of the material bond, for example the curing or solidifying of a connecting means, is therefore opposed. The production of such material bond on a pipe arrangement indicated above can be undertaken at the installation site. It is not necessary here for a fitter to fix the pipe section and the sleeve body with respect to each other by hand until the material bond between the components has set. As a result, the assembly time can be shortened and increased strength in the connection between the components to be joined in a material bond to one another can be obtained.

According to a preferred development, it is provided that the fixing means is designed as a clamping device which is configured to apply a clamping force to an outer surface of the sleeve body and to an inner side of the pipe section, arranged substantially congruently with respect to the outer surface of the sleeve body, or to mutually opposite outer surfaces of the sleeve body. Those surfaces of the components that are to be secured with respect to each other preferably lie directly against each other. In a preferred embodiment of the invention, the fixing means in the form of a clamping device is a pair of tongs which has clamping limbs which are connected to each other via a joint and can be brought from one side in each case to operative connection with regions of components to be fixed. The clamping device preferably has a locking unit by means of which the clamping limbs can be locked while maintaining a preset clamping force with respect to each other. A clamping action can therefore be produced via the clamping device and maintained without the clamping device having to be actuated further actively by hand.

In an alternative embodiment of the invention, the fixing means has a tensioning means which can be placed around the outer circumference of the sleeve body, preferably a tensioning chain, wherein the tensioning element is assigned a tensioning device which can change the tensioning length of the latter, and wherein at least one locking part is arranged along the tensioning element, said locking part penetrating the sleeve body at least in regions in the thickness direction upon tensioning of the tensioning device, and acting on the outer surface of the pipe section. Instead of providing a frictionally locking connection, based purely on a form-fitting connection, for fixing pipe section and sleeve body with respect to each other, with this embodiment of the fixing device according to the invention a locking part is preferably brought into contact with the outer surface of the pipe section. The locking part or the locking parts is or are preferably fixed on the outer surface of the pipe section by changing the tensioning length of the tensioning element. The locking part or the plurality of locking parts preferably reaches or reach through the sleeve body as far as the outer surface of the pipe section. The tensioning length of the tensioning element is preferably shortened by action of the tensioning device on the sleeve body, with the sleeve body being pressed against the tensioning element placed around the outer circumference of the sleeve body.

In a preferred embodiment, the locking part is in the form of a spike which is configured, if the sleeve body has corresponding properties in respect of the strength thereof, to penetrate material regions of the sleeve body during the tensioning of the tensioning element around the outer circumference of the sleeve body.

### BRIEF DESCRIPTION OF THE DRAWINGS

The invention will be described in more detail below using preferred exemplary embodiments with reference to the attached figures, in which:

FIG. 1 shows a schematic view of a pipe arrangement according to a first exemplary embodiment in section;

FIG. 2 shows a schematic view of a pipe arrangement according to the invention according to a second exemplary embodiment in section;

FIG. 3 shows a schematic view of a pipe arrangement according to the invention according to a further embodiment in section;

FIG. 4 shows a schematic view of a pipe arrangement according to the invention according to a further embodiment in section, and

FIG. 5 shows a view of an embodiment of an apparatus according to the invention for fixing a pipe arrangement.

### DETAILED DESCRIPTION OF THE INVENTION

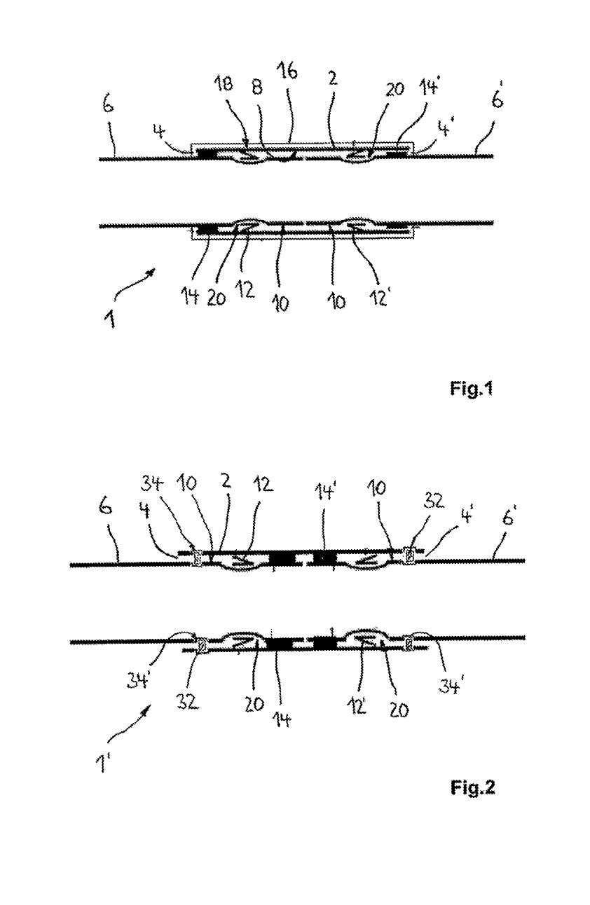

FIG. 1 shows a pipe arrangement 1 with a sleeve body 2 which has mutually opposite end sections 4, 4′. A pipe section 6, 6′ is accommodated in a sealing manner in each of the end sections 4, 4′. A sealing element 12, 12′, by means of which in particular the media-conducing sealing of the pipe arrangement 1 is ensured, is in each case arranged on an inner side 8 of the sleeve body 2 and an outer surface 10 of a respective pipe section 6, 6′. Furthermore, a connecting means 14, 14′ is arranged between the inner side 8 of the sleeve body 2 and the outer surfaces 10 of the pipe sections 6, 6′. The pipe sections 6, 6′ are in each case locked relative to the sleeve body 2 by means of the connecting means 14, 14′.

In one embodiment, the connecting means 14, 14′ is configured in order, in addition to locking the pipe sections relative to the sleeve body, to seal the inner side 8 of the sleeve body 2 with respect to the outer surfaces 10 of the pipe sections 6, 6′. The connecting means 14, 14′ are brought or transferred by means of activation from a transport and/or storage state into a connecting state in order to bring about a connection between the inner side 8 and the outer surfaces 10.

In a possible embodiment, the connecting means 14, 14′ are designed as an adhesive applied to the inner side 8 of the sleeve body 2 and/or to the outer surfaces 10 of the pipe sections 6, 6′ or as an applied, weldable plastic. In the embodiment shown in FIG. 1, the connecting means 14, 14′ are arranged at a distance from the end of a respective pipe section 6, 6′ that is greater than the distance of the sealing elements 12, 12′ from the end of a respective pipe section 6, 6′. Furthermore, insulation 16 is provided which is arranged on an outer surface 18 of the sleeve body 2.

FIG. 2 shows a second embodiment of a pipe arrangement 1′ according to the invention which likewise comprises a sleeve body 2 and pipe section 6, 6′ accommodated therein on the end side. In the present embodiment, the end sections 4, 4′ of the sleeve body 2 are arranged coaxially. In another embodiment, the sleeve body can also be angled, and therefore the center axes of the end portions 4, 4′ run at an angle of between 1° and 90° with respect to each other.

In a preferred embodiment, the sleeve body can also be designed as a T connector or X connector, wherein a T connector in particular has three end sections for receiving a respective pipe section and an X connector has four end sections, running at angles to one another, for receiving pipe sections.

By contrast to the embodiment according to FIG. 1, the connecting means 14, 14′ are arranged at a distance from the end of a respective pipe section 6, 6′ that is smaller than the distance of the sealing elements 12, 12′ from a respective end of the pipe sections 6, 6′. The connecting means 14, 14′ are therefore arranged in front of the sealing elements 12, 12′ in the push-direction of the pipe sections 6, 6′. In the present embodiment, the sleeve body is not enclosed by insulation, but this is possible in one embodiment.

The connecting means 14, 14′ shown in FIG. 2 can also be transferred from a transport and/or storage state into a connecting state by corresponding activation, and therefore the inner side 8 of the sleeve body 2 is connected to the outer surfaces 10 of the pipe sections 6, 6′. Although not illustrated in detail, the connecting means 14, 14′ from FIG. 2 can have through-ducts running in the axial direction, and therefore the fluid flowing through the pipe sections, in particular an extinguishing fluid, enters into contact with the sealing elements 12, 12′ arranged between the outer surfaces 10 and the inner side 8 behind the connecting means 14, 14′ in the outflow direction of the extinguishing fluid.

As is apparent from FIGS. 1 and 2, the sealing elements 12, 12′ are each arranged in groove-like depressions 20 on the outer surfaces 10 of the pipe sections 6, 6′. The connecting means 14, 14′ can also be accommodated, for example, in similar depressions on, for example, the outer surfaces 10 of the pipe sections and/or regions of the inner side 8 of the sleeve body 2′. In one embodiment of the invention, the connecting means 14, 14′ can be a two-component adhesive, wherein the first component is in each case supplied to the outer surface 10 of a respective pipe section 6, 6′ and the second component of the inner side 8 of the sleeve body 2.

Furthermore, for the activation of the connecting means, which is an adhesive, the connecting means can be covered in the transport and/or storage state by a removable protective layer 15 which is simply removed in order to activate the connecting means. The protective layer 15 can be removed before the pipe sections 6, 6′ are inserted into the sleeve body 2 or only after the pipe sections are inserted into the sleeve body. Alternatively, in the case of a weldable plastic as the connecting means, heat acts on an associated region of the sleeve body 2. In the embodiment shown in FIG. 2, a locking element 32 is in each case provided on each pipe section 6, 6′, said locking element interacting with a section of the sleeve body 2 and engaging in recesses 34, 34′ in the form of an annular groove, on the inner side 8 of the sleeve body 2 with respect to the outer surfaces 10 of the pipe sections 6, 6′.

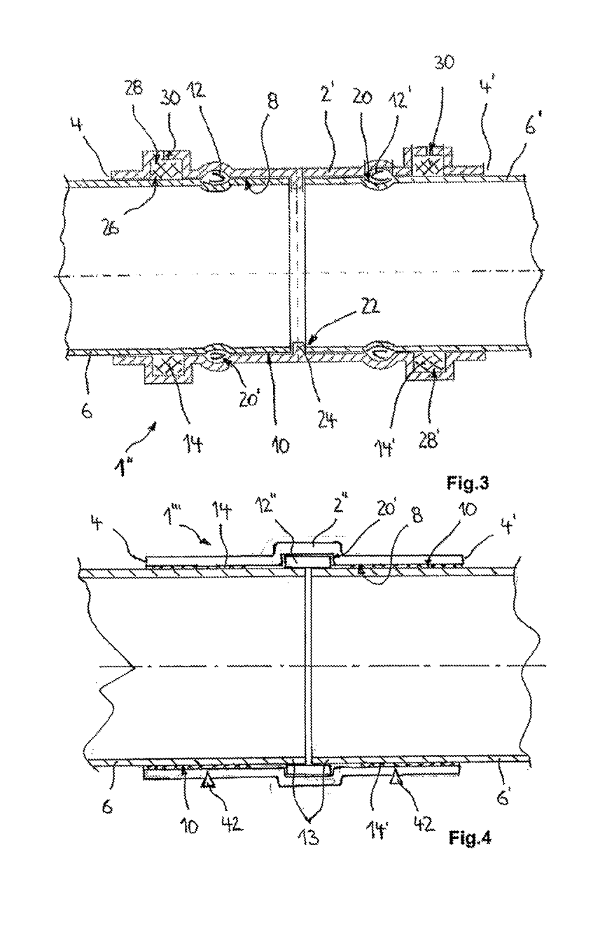

FIG. 3 shows a further embodiment of a pipe arrangement 1″ according to the invention which comprises a sleeve body 2′. Pipe sections 6, 6′ are likewise inserted on the end sides of the sleeve body 2′. The sleeve body 2′ has a stop 22 which is formed approximately halfway along in the longitudinal direction of the sleeve body. The stop 22 is a material projection 24, which protrudes on the inner side 8 of the sleeve body 2′, in the form of a shoulder on the inner side 8 of the sleeve body. The insertion depth for the pipe sections 6, 6′ is limited via the stop 22.

Groove-like depressions 20, 26 are in each case provided on the outer surfaces of the pipe sections 6, 6′ and the inner side 8 of the sleeve body 2′. In particular receiving spaces 28, 28′ for the sealing elements 12, 12′ and the connecting means 14, 14′ are formed by means of the depressions 20, 26. In the embodiment shown in FIG. 3, the sleeve body 2′ has an opening 30, which penetrates the wall of the sleeve body, in the region of the depression 26 forming the receiving space 28, 28′ for the connecting means. After the pipe arrangement 1″ has been assembled, the connecting means 14, 14′ can be entered into the receiving space 28, 28′ via the opening 30.

FIG. 4 shows a further embodiment of a pipe arrangement 1′″ according to the invention with a sleeve body 2″, into which two pipe sections 6, 6′ have been pushed in each case on the end sides into the end sections 4, 4′ thereof. The inner side 8 of the sleeve body 2″ is then at least partially in contact with the outer surface 10 of a respective pipe section 6, 6′. Contrary to the previous embodiments, the sleeve body 2″ has a centrally arranged sealing element 12″ which simultaneously provides sealing in relation to both ends 13 of the pipe sections 6, 6′. After the pipe sections have been inserted into the sleeve body 2″, the connecting means 14, 14′ between the inner side 8 of the sleeve body 2″ and the outer surfaces 10 of the pipe sections 6, 6′ is activated.

In order to avoid axial displacement of the pipe sections 6, 6′ relative to the sleeve body 2″ or a rotation of the pipe sections in the circumferential direction in the sleeve body 2″, the pipe sections 6, 6′ and the sleeve body 2″ are fixed relative to each other during the setting of the at least partial material bond between the sleeve body and the pipe sections.

As indicated in FIG. 4, the sleeve body 2″ can be fixed relative to the pipe sections 6, 6′ by means of one or more locking parts 42. In one embodiment, the sleeve body 2″ can have a material strength which is penetrated at least in regions in the thickness direction by the spike-like locking parts 42. The locking parts 42 are then preferably directly operatively connected to the outer surface 10 of the pipe sections 6, 6′. In one embodiment of the invention, the sleeve body 2″ can also have premanufactured recesses running in its wall surface in the thickness direction, for the locking parts 42 to reach through.

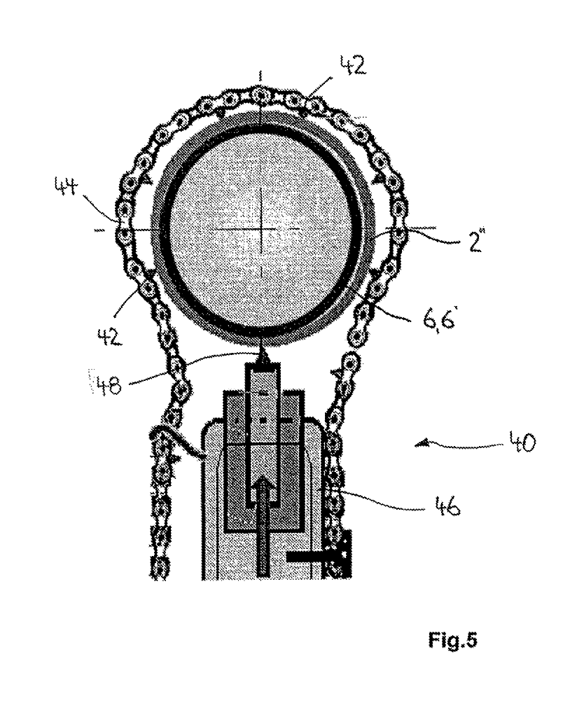

FIG. 5 shows a possible embodiment of a fixing apparatus 40 which is used and which has at least one tensioning element 44 which can be placed around the outer circumference of the sleeve body 2″ and on which a plurality of locking parts 42 are arranged at predetermined distances along the tensioning element. The fixing apparatus 40 furthermore comprises an adjustable tensioning device 46 with a movably mounted tensioning pin 48 which exerts a compressive force from one side on the sleeve body 2″, around which the tensioning element is wrapped. As a result, the sleeve body 2″ is pressed against the locking parts 42 of the tensioning element 44. The tensioning pin 48 is moved by means of a drive unit (not illustrated specifically), such as, for example, an adjustable piston.

Instead of a previously described fixing apparatus 31, it is also possible to use a type of securing tong in order to fix the pipe sections 6, 6′ and the sleeve body relative to each other. The securing tongs are preferably used to produce a clamping force on the inner side of a pipe section 6, 6′ and an approximately opposite outer surface of the sleeve body 2″, by means of which the region of the inner side of the sleeve body and the outer surface of the corresponding pipe section are secured by means of the effective surface pressure.

### REFERENCE NUMBERS

1, 1′, 1″, 1′″ pipe arrangement

2, 2′, 2″ sleeve body

4, 4′ end section

6, 6′ pipe section

8 inner side

10 outer surface

12, 12′, 12″ sealing element

13 end

14, 14′ connecting means

15 protective layer

16 insulation

18 outer surface

20, 20′ depression

22 stop

24 material projection

26 depression

28, 28′ receiving space

30 opening

32 locking element

34, 34′ recess

40 fixing apparatus

42 locking part

44 tensioning element

46 tensioning device

48 tensioning pin

1. A pipe arrangement of a pipeline system of a fire extinguishing system having interconnected media-conducting pipe sections, comprising
a sleeve body which has at least one first end section and a second end section, two pipe sections, wherein each pipe section is accommodated on an end section of the sleeve body, and
a sealing element arranged between an inner side of the sleeve body and an outer surface of the pipe section,
wherein a connecting means arranged between the inner side of the sleeve body and the outer surface of the pipe section, and
wherein the connecting means has a transport and/or storage state in which a relative movement between the pipe sections and the sleeve body is possible, and which can be brought by means of activation from the transport and/or storage state into a connecting state, wherein, in the connecting state, the connecting means is configured to connect an outer surface of the respective pipe end to the inner side of the sleeve body by material bonding.

2. The pipe arrangement according to claim 1, wherein an adhesive or welded connection is formed between the sleeve body and the pipe sections by means of the connecting means.

3. The pipe arrangement according to claim 1, wherein the connecting means is an adhesive or weldable plastic applied on the inner side of the sleeve body and/or the outer surface of the pipe section.

4. The pipe arrangement according to claim 1, wherein the connecting means is a single- or multi-component adhesive, preferably a two-component adhesive.

5. The pipe arrangement according to claim 1, wherein a section of a conically running connecting surface is in each case provided on the inner side of the sleeve body and on the outer surface of the pipe section.

6. The pipe arrangement according to claim 1, wherein the connecting means is covered by a removable protective layer, wherein the protective layer is configured to shield the connecting means from external influences in its transport and/or storage state.

7. The pipe arrangement of claim 6, wherein the protective layer is formed as a protective film that completely encloses the connecting means wherein preferably, the protective film is configured to be removed from the connecting means when the pipe section has already been pushed onto the end section of the sleeve body.

8. The pipe arrangement of claim 6, wherein the removable protective layer is at least one of: Air tight, Splash water repellent, or Impermeable to UV radiation.

9. The pipe arrangement of claim 6, wherein the connecting means is configured to transition into the connecting state with removal of the protective layer.

10. The pipe arrangement according to claim 1, wherein the sealing element in arranged in a depression on the inner side of the sleeve body and/or on the outer surface of the pipe section.

11. The pipe arrangement according to claim 1, wherein the inner side (8) of the sleeve body and the outer surface of the pipe section define a receiving space for receiving the connecting means, wherein an opening corresponding to the receiving space for the entry of the connecting means or an initiator or a component of the connecting means is provided on the sleeve body.

12. The pipe arrangement according to claim 1, furthermore having a locking element for axially positioning the pipe sections with respect to the sleeve body.

13. The pipe arrangement according to claim 1, wherein the sleeve body has at least one stop for the pipe sections pushed into the sleeve body, said stop preferably being designed as a radially inwardly projecting shoulder on the inner side of the sleeve body.

14. The pipe arrangement according to claim 1, wherein the connecting regions formed by means of the connecting means are at a distance from the respective end of the pipe section that is greater than the distance of the sealing element from the end of the pipe section.

15. The pipe arrangement according to claim 1, wherein the connecting regions formed by means of the connecting means are at a distance from the respective end of the pipe section that is smaller than the distance of the sealing element from the end of the pipe section.

16. The pipe arrangement according to claim 1, wherein, in the circumferential direction of the pipe section, the connecting means has cooling ducts extending substantially in the axial direction.

17. The pipe arrangement according to claim 1, wherein insulation is arranged on the outer surface of the sleeve body.

18. A fire extinguishing system with a pipeline system consisting of a plurality of media-guiding pipelines which are connected to one another in a fluid-conducting manner, wherein the connecting region of at least two interconnected pipelines is formed by means of a pipe arrangement according to claim 1.

19. A pipe connector for a pipe arrangement of a pipeline system of a fire extinguishing system, said system having a plurality of interconnected fluid-conducting pipe sections,
wherein the pipe connector comprises:
a sleeve body that comprises a first end section for receiving a first pipe section of the pipe arrangement and a second end section for receiving a second end pipe section of the pipe arrangement,
wherein the sleeve body comprises an inner side, and a sealing element arranged on the inner side,
wherein the sleeve body comprises a connecting means that is arranged on the inner side of the sleeve body, said connecting means being configured to connect to an outer surface of the respective pipe section,
wherein the connecting means has a transport and/or storage state in which a relative movement between the pipe sections and the sleeve body is possible, and which is configured to be activated from the transport and/or storage state into a connecting state, wherein, in the connecting state, the connecting means is configured to connect to an outer surface of the respective pipe section by material bonding.

20. A method for producing a pipe arrangement of two pipelines, to be connected to each other, of a pipeline system of a fire extinguishing system, comprising:
providing at least one pipe section and a sleeve body for receiving at least sections of the pipe section,
joining the pipe section to the sleeve body,
activating a connecting means, which is arranged on an inner side of the sleeve body and/or on an outer surface of the pipe section, before or after the joining and transfer of the connecting means from a transport and/or storage state into a connecting state such that the inner side of the sleeve body is at least partially connecting in a material bond to the outer surface of the pipe section by means of the activated connecting means.

21. The method according to claim 20, comprising the step: fixing the pipe section and the sleeve body with respect to each other after the joining of the pipe section to the sleeve body until the at least partial material bond between the inner side of the sleeve body and the outer surface of the pipe section is set.

22. The method according to claim 20, wherein, in order to activate the connecting means before or after the connection of the pipe sections to the sleeve body, one, more than one or all of the following steps are carried out:
a) removing a protective layer covering the connecting means, b) generating heat at the connecting means such that the connecting means liquefies, and subsequently cooling the connecting means in order to solidify the connecting means, and
c) entering the connecting means or an initiator or a component of the connecting means into a receiving space, which is formed between the inner side of the sleeve body and the outer surface of the pipe section, for receiving the connecting means via an opening corresponding to a receiving space.

23. A system for pipe installation, with a pipe connector according to claim 19 and an apparatus for fixing at least one pipe section and a sleeve body of the pipe connector to be connected to the pipe section, with at least one fixing means which acts on the pipe section and the sleeve body and is configured to secure the pipe section and the sleeve body in the axial direction and/or in the circumferential direction of the mutually facing inner side and outer surface at least temporarily with respect to each other.

24. The system according to claim 23, wherein the fixing means is designed as a clamping device which is configured to apply a clamping force to an outer surface of the sleeve body and to an inner side of the pipe section arranged substantially congruently to the outer surface of the sleeve body, or to mutually opposite outer surfaces of the sleeve body (such that a surface pressure is brought about in at least one contact region between the inner side of the sleeve body and the outer surface of the pipe section.

25. The system according to claim 23, wherein the fixing means has a tensioning means which can be placed around the outer circumference of the sleeve body, preferably a tensioning chain, wherein the tensioning element is assigned a tensioning device which can change the tensioning length of the latter, and wherein at least one locking part is arranged along the tensioning element, said locking part penetrating the sleeve body at least in regions in the thickness direction upon tensioning of the tensioning device, and acting on the outer surface of the pipe section.
